(19) United States
(12) Patent Application Publication
(10) Pub. No.: US 2024/0311098 A1
(43) Pub. Date: Sep. 19, 2024

(54) AUTOMATED DATA MODELING

(71) Applicant: SAP SE, Walldorf (DE)

(72) Inventors: Mohd Danish Imam, Bangalore (IN); Kumar Priyam, Riverside, CA (US); Srinivas S, Bangalore (IN); Ravi Konaraddi, Bangalore (IN); Arindam Bhuin, Bangalore (IN)

(21) Appl. No.: 18/184,121

(22) Filed: Mar. 15, 2023

(51) Int. Cl. G06F 8/35; G06F 8/10; G06F 8/33; G06F 8/36

(52) U.S. Cl. CPC G06F 8/35; G06F 8/10; G06F 8/33; G06F 8/36

(57) ABSTRACT

Mechanisms are disclosed for automated data services source code generation based on an agreed data model. A graphical representation of the agreed data model is received. The graphical representation of the agreed data model is transformed into a data file corresponding to the graphical representation of the agreed data model. One or more hierarchically arranged core data services views is displayed to enable a user to identify a core data services view to be created. A selection is received of a selected core data services view associated with the one or more hierarchically arranged core data services views. The data services source code is generated based on the imported contents associated with the underlying data file and one or more code frameworks associated with the selected core data services view.

### TECHNICAL FIELD

Embodiments generally relate to automated data modeling, and more particularly to automated data services source code generation based on a data model.

Core data services (CDS) is an infrastructure that can be used to define and consume semantically rich data models in connection with an in-memory data system (IMDB). A model described in connection with a CDS enables an IMDB developer to use a data definition language (DDL) to define artifacts that make up a data-persistence model associated with an IMDB application. The developer may save a data-persistence object definition as a CDS artifact, that is; a design-time object that the developer can manage in a repository associated with the IMDB, activating when necessary. Using a DDL, a query language (QL), and an expression language (EL), a CDS enables certain operations such as write operations and transaction semantics. The developer can use the CDS specification to create a CDS document which defines various artifacts and elements. CDS artifacts are design-time definitions that are used to generate corresponding run-time objects, when the CDS document that contains the artifact definitions is activated in the IMDB repository. In CDS, the objects can be referenced using the name of the design-time artifact in the repository; in SQL, only the name of a corresponding catalog object can be used.

After the design of the CDS, views are finalized and the model is created using a modelling tool. The developer has to implement source code and create the agreed artifacts manually. This means that the developer has to write the entire code with all the select, join conditions, mandatory associations, and projection list repeatedly. The developer has to write a lot of boiler plate code for a particular data model design. This process is also typically repeated if underlying requirements change. This means the developer has to again write a new set of boilerplate code for new designs. Such repetition is a time-consuming process. Moreover, the developer has to adhere to specific virtual data model (VDM) guidelines to create CDS artifacts to avoid generating compatibility errors and to provide a harmonized experience for the artifacts developed. Accordingly, what is needed is a mechanism for automated data services source code generation based on a data model that overcomes the above-described problems and challenges.

### SUMMARY

Disclosed embodiments address the above-mentioned problems by providing one or more non-transitory computer-readable media storing computer-executable instructions that, when executed by a processor, perform a method for automated data services source code generation based on a data model, the method comprising: receiving a graphical representation of the agreed data model, transforming the graphical representation of the agreed data model into a data file corresponding to the graphical representation of the agreed data model, displaying one or more hierarchically arranged core data services views to enable a user to identify a core data services view to be created, receiving a selection of a selected core data services view associated with the one or more hierarchically arranged core data services views, and generating the data services source code based on the imported contents associated with the underlying data file and the selected core data services view, wherein the generated source code is compliant with virtual data model requirements.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE DRAWING FIGURES

Embodiments are described in detail below with reference to the attached drawing figures, wherein:

FIG. 1 is an example architectural diagram illustrating mechanisms for automated data services source code generation based on a data model consistent with the present teachings.

FIG. 2 is an example modeling diagram illustrating an example graphical representation of an agreed data model consistent with the present teachings.

FIG. 3A is an example user interface diagram illustrating an overall architecture of core data services views in connection with automated data services source code generation based on a data model consistent with the present teachings.

FIG. 3B is another example user interface diagram illustrating an overall architecture of core data services views in connection with automated data services source code generation based on a data model consistent with the present teachings.

FIG. 4 is an example flow diagram illustrating an example method for automated data services source code generation based on a data model according to certain embodiments.

FIG. 5 is a diagram illustrating a sample computing device architecture for implementing various aspects described herein.

The drawing figures do not limit the present teachings to the specific embodiments disclosed and described herein. The drawings are not necessarily to scale, emphasis instead being placed upon clearly illustrating the principles of the disclosure.

### DETAILED DESCRIPTION

The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The following detailed description of embodiments references the accompanying drawings that illustrate specific embodiments in which the present teachings can be practiced. The described embodiments are intended to illustrate aspects of the present teachings in sufficient detail to enable those skilled in the art to practice the present teachings. Other embodiments can be utilized, and changes can be made without departing from the claims. The following detailed description is, therefore, not to be taken in a limiting sense. The scope of embodiments is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

### Overview

The present teachings describe methods and systems for automated data services source code generation based on a designed data model. Designed systems and/or applications consistent with the present teachings allow developers to create necessary CDS artifacts directly from the designed data model. Such a designed system synthesizes a relation between different CDS views in terms of select, joins, associations, and unions, for example, and creates virtual data model (VDM) compliant code automatically from the CDS model. Such a designed system may also provide an overview in terms of hierarchy regarding different CDS views and corresponding relations. Such a designed system may also support creation of both programming-language-defined CDS views and CDS entities. The main difference between the CDS view entities and plain CDS views is that, for view entities, no SQL view is generated. Instead, the view entity itself may be created on an in-memory database management system and used for runtime accesses. Such a designed system may integrate an overall developer experience by providing edit features, thus enabling developers to edit corresponding generated code. Such a designed system may also provide integrated transport management to enable created objects to be locked and transported (or deployed) to different software and/or hardware landscapes, whether on premise or in the cloud.

Designed systems consistent with the present teachings generate VDM compliant code directly from modelling tool file contents or other data model content such as a generic data container which may be any container for storing data such as a set, list, or array, thus saving significant resources that would otherwise be required to be put forth by developers. In some cases, developers need not write code. In other cases, developers need only review generated code for correctness or to add specific details not provided for in corresponding designed data models. Designed systems may identify associated hierarchies and in connection therewith generate corresponding annotations, join conditions, and associations, for example. Such systems may enable end users to modify generated code directly from a modelling tool, thus enabling developers to only make the absolute necessary changes and not spend time writing boiler plate code. Such designed systems may support various types of CDS constructs, functions such as left outer join, inner join, right outer join, union, union all and associations, for example. Such a designed system may identify relationships between different CDS views and generate associated join conditions automatically. Key fields may be generated by the designed system automatically. A designed system may generate fully qualified names so that naming conflicts do not occur. A designed system may expose associations in a projection list for high reusability. A projection list in general is a list of attributes including associations that are projected in a CDS view. These attributes, associations can be accessed from another CDS view or program accessing the CDS view.

Insights may be provided to end users in term hierarchy of particular CDS views. Designed systems may support both programming-language-defined CDS as well as CDS entities thus providing an end-to-end platform for data source creation. Support and extension capabilities may be provided for a plurality of modelling tools.

### Operational Environment for Embodiments

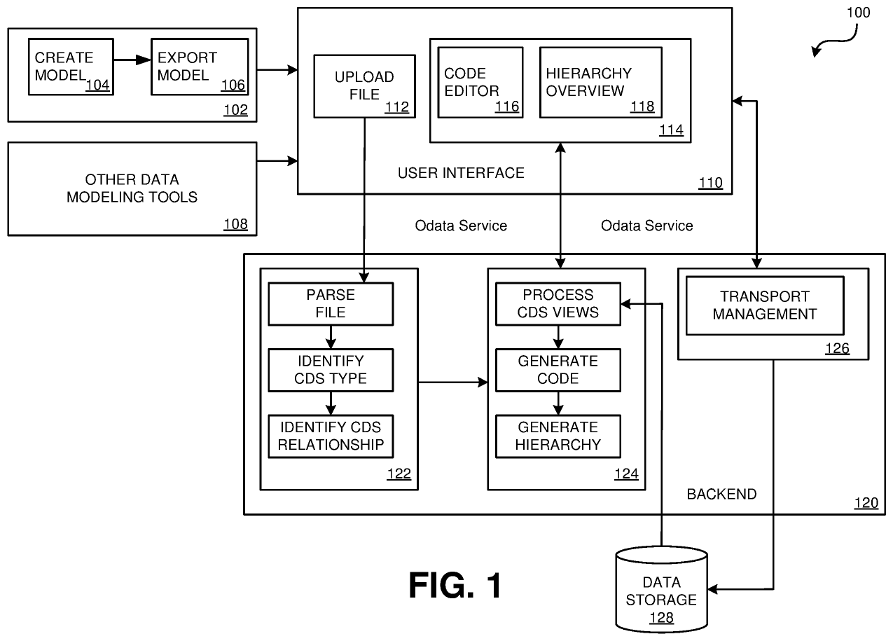

FIG. 1 is an example architectural diagram 100 illustrating mechanisms for automated data services source code generation based on a data model consistent with the present teachings. Modeling tool 102 may be any type of data modeling tool that can be used to model interrelationships between data objects and entities. In connection with modeling tool 102 a user may create a data model for a CDS using model creation functionality 104. In some embodiments, modeling tool 102 may be caused to export data model contents in connection with model exporting functionality 106. In some embodiments, modeling tool 102 may be a diagram creation application such as Diagrams.net (previously draw.io), which is an open source cross-platform graph drawing software developed in HTML5 and JavaScript. In some embodiments, modeling tool 102 may run in a web browser, with the capability of uploading an exported model in the form of an Extensible Markup Language (XML). In some other embodiments modeling tool 102 may be a stand-alone application. Data model content from modeling tool 102 may then be provided to user interface 110. In some embodiments, other data modeling tools 108 may be used to generate one or more designed data models, which content may then be received by user interface 110.

User interface 110 may contain file upload functionality 112, which may be used to provide data model content to backend 120. In some embodiments, the data model content may be provided in the form of an XML file containing tags and elements associated with the data model content. In these embodiments, the data model content (in the form of an XML file or corresponding data stream) may be provided to content parser 122 that is associated with backend 120. In some such embodiments, the associated file is first parsed to isolate relevant data model content contained within the XML file. Next, a type of CDS to be created may identified from the parsed contents. In some case the CDS type may be programming-language-defined CDS or CDS entities. Next, the data model contents may be further processed to identify relationships between different types of CDS views. Some different type of CDS views are Basic views, Composite views, Consumption Views, Transactional Views, Private Views, extension views etc.

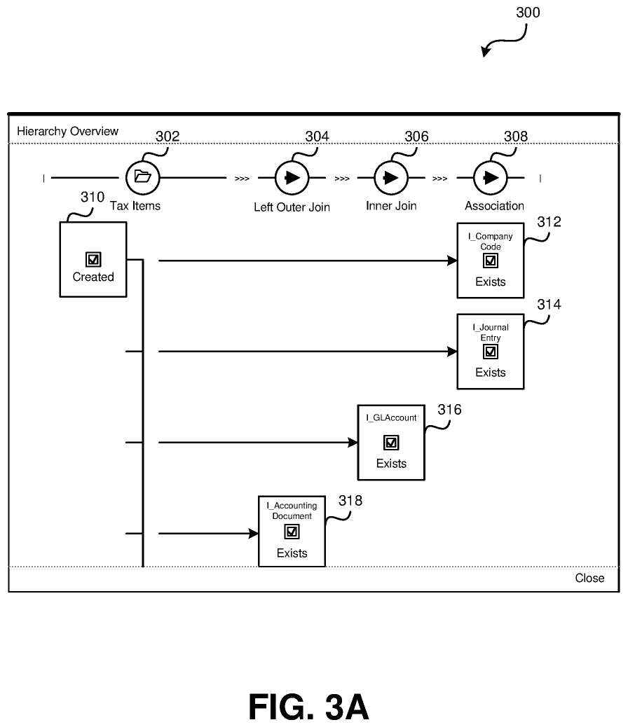

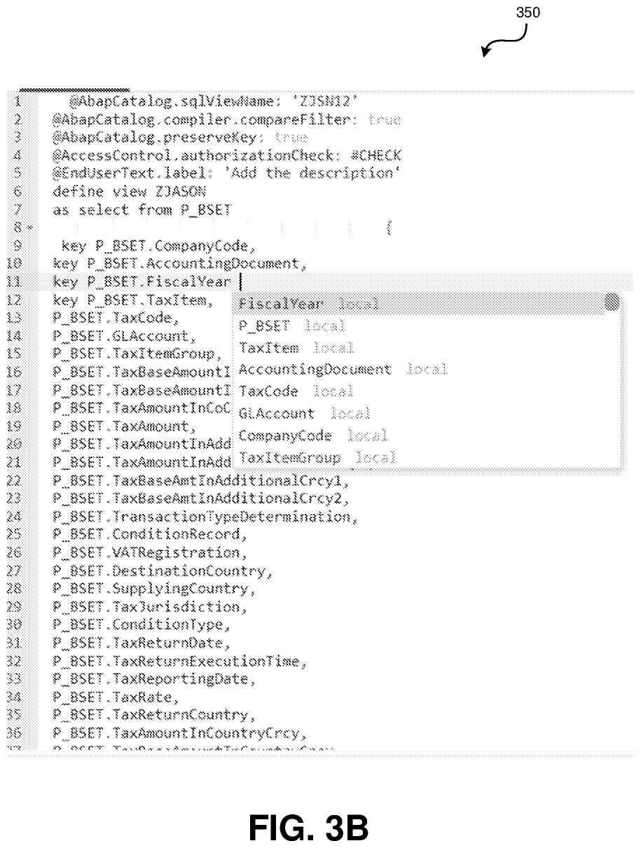

As shown in connection with the arrow from content parser 122 to code generator 124, data associated with data model content that was processed in connection with content parser 122 is transmitted to code generator 124 so that existing CDS views may be processed according to CDS views referenced in the processed data model content. In some embodiments, existing CDS views may be accessed from data storage 128, which may be any kind of persistent digital data storage. Based on the processed data model content, VDM compliant code may be generated as well as generating a hierarchy of existing and generated CDS views. Once generated in connection with code generator 124, such hierarchical content may be transmitted back to user interface 110 and displayed in connection with user interface 110, which may contain development environment 114. Development environment 114 may contain code editor 116, which may be used to validate and/or update code that was generated in connection with code generator 124. Additionally, a hierarchy of the assembled CDS views may be visualized in connection with hierarchy overview 118, which is further described in connection with FIG. 3A below.

Once validated, code that has been generated in connection with code generator 124, visualized and potentially edited in connection with development environment 114 may then be transmitted to deployment platform 126, which may employ transport management techniques to deploy new and/or updated code that has been generated in connection with the steps above. In some embodiments, the code to be transported may be persisted in connection with data storage 128.

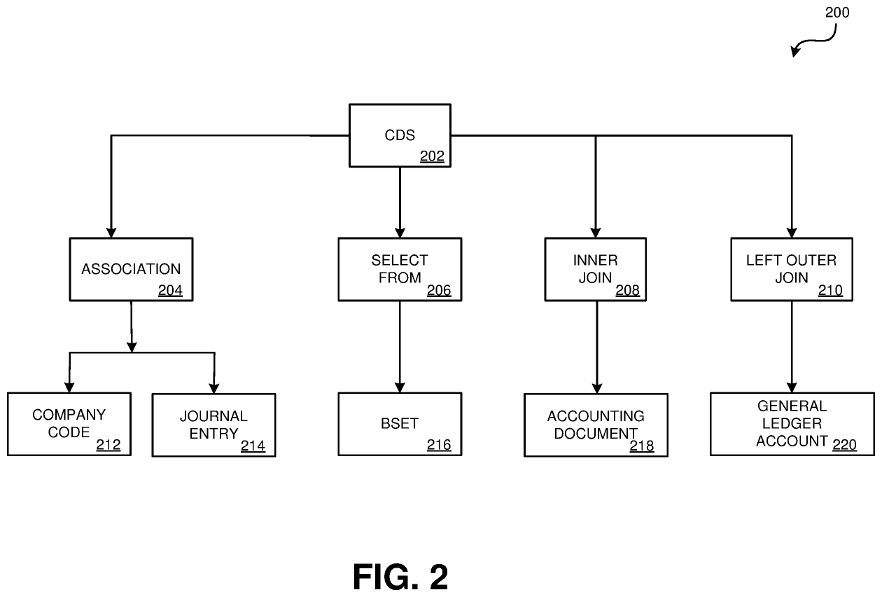

FIG. 2 is an example modeling diagram 200 illustrating an example graphical representation of an agreed data model consistent with the present teachings. Such a data model may conform to pre-defined requirements for obtaining data objects from one or more complex data sources, such as a data storage associated with an enterprise resource planning application or a data warehouse, for example. As shown in modeling diagram 200, a CDS value 202 may be constructed from various components including association 204, which itself is derived from company code 212 and journal entry 214. Diagram 200 may also include right outer join, union, and union all.

Next, a further component for constructing CDS value 202 is an operation select from 206, which itself consumes data from another CDS view entitled “P_Bset” at object BSET 216. P_Bset is another CDS view which is based on database table BSET. That is to say that P_Bset selects from BSET. P_Bset may be a private view based on the database table BSET. A next component is inner join 208, which performs an inner join on contents associated with one or more accounting documents 218. Finally left outer join 210 performs a left outer join on contents associated with general ledger account 220. In some embodiments, multiple hierarchies may be provided. In these embodiments, a corresponding data model may include more than one level of hierarchy.

FIG. 3A is an example user interface diagram 300 illustrating an overall architecture of core data services views in connection with automated data services source code generation based on a data model consistent with the present teachings. The illustrated hierarchy overview corresponds to the agreed data model illustrated above in connection with FIG. 2 above. A data model corresponding to tax items 302 is constructed according to various operations as shown in connection with left outer join 304, inner join 306, and association 308. As shown, CDS value 310 is shown as created, and a hierarchical view of existing CDS views is rendered for the user to visualize structure of the underlying CDS views. Existing CDS views 312, 314, 316, and 318 are designated as existing with the exemplary label “Exists.” Once visualization is complete a user may interact with the close object to close the user interface component.

FIG. 3B is another example user interface diagram 350 illustrating a code editor consistent with the present teachings. In this example, the code editor comprises integrated autocompletion according to an embodiment.

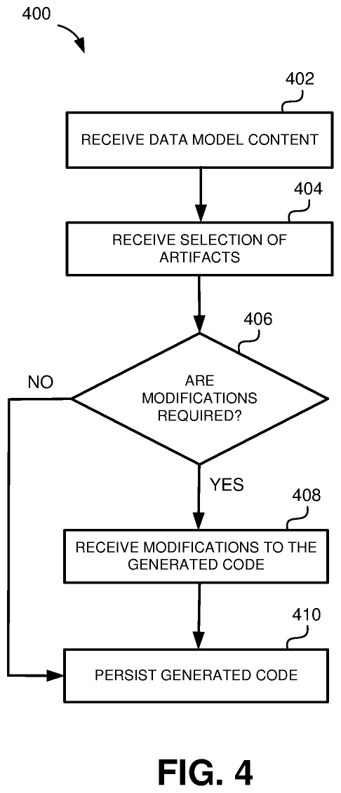

FIG. 4 is an example flow diagram 400 illustrating an example method for automated data services source code generation based on a data model according to certain embodiments. In some embodiments, one or more non-transitory computer-readable media storing computer-executable instructions are provided that, when executed by a processor, perform a method of automated data services source code generation based on an agreed data model. At step 402, a graphical representation of the agreed data model may be received. In some embodiments, the graphical representation of the agreed data model may be transformed into a data file or other container corresponding to the graphical representation, representing the agreed data model. In some embodiments, the data file may take on a format consistent with a JavaScript Object Notation (JSON) format. Next, one or more hierarchically arranged core data services views may be displayed to enable a user to identify a core data services view to be created, which may involve rendering one or more artifacts associated with a selected core data services view associated with the one or more hierarchically arranged core data services views.

In some embodiments, a selected core data services view may be associated with the one or more hierarchically arranged core data services views. In some such embodiments, displaying the one or more hierarchically arranged core data services views to enable the user to identify the core data services view to be created further involves displaying the one or more hierarchically arranged core data services views as a multiply hierarchical data model comprising more than one level of hierarchy. In some embodiments, the core data services view comprises one or more private views. In some such embodiments, displaying the one or more hierarchically arranged core data services views may be performed in connection with a hierarchical object rendering framework. In some embodiments an interface may be provided to enable browsing one or more hierarchically arranged core data services views to identify a core data services view that needs to be created.

Next, at step 404, a selection of a selected core data services view associated with the one or more hierarchically arranged core data services views may be received. Data services source code may be generated based on imported contents associated with an underlying data file and the selected core data services view, wherein the generated source code is compliant with virtual data model requirements. In these embodiments, the imported contents may be imported in connection with an intelligent artifact creation application that provides context for content importation based on the selected core data services view.

Next at test 406, it may be determined whether modifications to the generated source code are required. If changes are required, modifications to the generated code are received at 408. If no changes are required, at step 410, the generated code may be persisted to a persistent data store. In some embodiments, generating the data services source code may further involve providing an integrated development environment in which the user may further edit initially generated code. In these embodiments, the integrated development environment in which the user may further edit initially generated code provides source code auto complete functionality based on the initially generated code.

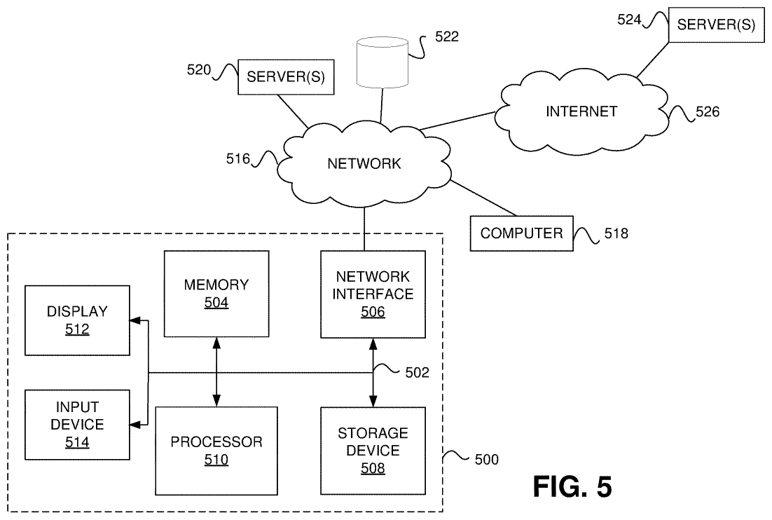

FIG. 5 is a diagram illustrating a sample computing device architecture for implementing various aspects described herein. Computer 500 can be a desktop computer, a laptop computer, a server computer, a mobile device such as a smartphone or tablet, or any other form factor of general- or special-purpose computing device containing at least one processor that may be employed to cause actions to be carried out. Depicted with computer 500 are several components, for illustrative purposes. Certain components may be arranged differently or be absent. Additional components may also be present. Included in computer 500 is system bus 502, via which other components of computer 500 can communicate with each other. In certain embodiments, there may be multiple busses or components may communicate with each other directly. Connected to system bus 502 is processor 510. Also attached to system bus 502 is memory 504. Also attached to system bus 502 is display 512. In some embodiments, a graphics card providing an input to display 512 may not be a physically separate card, but rather may be integrated into a motherboard or processor 510. The graphics card may have a separate graphics-processing unit (GPU), which can be used for graphics processing or for general purpose computing (GPGPU). The graphics card may contain GPU memory. In some embodiments no display is present, while in others it is integrated into computer 500. Similarly, peripherals such as input device 514 is connected to system bus 502. Like display 512, these peripherals may be integrated into computer 500 or absent. Also connected to system bus 502 is storage device 508, which may be any form of computer-readable media, such as non-transitory computer readable media, and may be internally installed in computer 500 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface 506 is also attached to system bus 502 and allows computer 500 to communicate over a network such as network 516. Network interface 506 can be any form of network interface known in the art, such as Ethernet, ATM, fiber, Bluetooth, or Wi-Fi (i.e., the Institute of Electrical and Electronics Engineers (IEEE) 802.11 family of standards). Network interface 506 connects computer 500 to network 516, which may also include one or more other computers, such as computer 518, server(s) 520, and network storage, such as cloud network storage 522. Network 516 is in turn connected to public Internet 526, which connects many networks globally. In some embodiments, computer 500 can itself be directly connected to public Internet 526 as well as one or more server(s) 524.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although the invention has been described with reference to the embodiments illustrated in the attached drawing figures, it is noted that equivalents may be employed, and substitutions made herein without departing from the scope of the invention as recited in the claims. The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The following detailed description of embodiments references the accompanying drawings that illustrate specific embodiments in which the present teachings can be practiced. The described embodiments are intended to illustrate aspects of the disclosed invention in sufficient detail to enable those skilled in the art to practice the invention. Other embodiments can be utilized, and changes can be made without departing from the claimed scope of the invention. The following detailed description is, therefore, not to be taken in a limiting sense. The scope of embodiments is defined only by the appended claims, along with the full scope of equivalents to which such claims are entitled.

Having thus described various embodiments of the invention, what is claimed as new and desired to be protected by Letters Patent includes the following:

1. One or more non-transitory computer-readable media storing computer-executable instructions that, when executed by a processor, perform a method of automated data services source code generation based on an agreed data model, the method comprising:
receiving a graphical representation of the agreed data model;
transforming the graphical representation of the agreed data model into a data file corresponding to the graphical representation of the agreed data model;
displaying one or more hierarchically arranged core data services views to enable a user to identify a core data services view to be created;
receiving a selection of a selected core data services view associated with the one or more hierarchically arranged core data services views; and
generating the data services source code based on imported contents associated with an underlying data file and the selected core data services view,
wherein the generated source code is compliant with virtual data model requirements.

2. The non-transitory computer-readable media of claim 1, wherein the graphical representation of the agreed data model is generated in connection with a graphical modeling tool.

3. The non-transitory computer-readable media of claim 1, wherein displaying the one or more hierarchically arranged core data services views to enable the user to identify the core data services view to be created further comprises displaying the one or more hierarchically arranged core data services views as a multiply hierarchical data model comprising more than one level of hierarchy.

4. The non-transitory computer-readable media of claim 1, wherein the core data services view comprises one or more private views.

5. The non-transitory computer-readable media of claim 1, wherein displaying the one or more hierarchically arranged core data services views is performed in connection with a hierarchical object rendering framework.

6. The non-transitory computer-readable media of claim 1, wherein generating the data services source code further comprises providing an integrated development environment in which the user may further edit initially generated code.

7. The non-transitory computer-readable media of claim 6, wherein integrated development environment in which the user may further edit initially generated code provides source code auto complete functionality based on the initially generated code.

8. A method for automated data services source code generation based on an agreed data model, the method comprising:
receiving a graphical representation of a designed data model;
exporting an underlying data container corresponding to the graphical representation of the designed data model;
importing contents associated with the underlying data container into an intelligent artifact creation application;
browsing one or more hierarchically arranged core data services views to identify a core data services view that needs to be created;
selecting a selected core data services view from the one or more hierarchically arranged core data services views; and
generating the data services source code based on imported contents associated with the underlying data container,
wherein the generated source code is compliant with virtual data model requirements.

9. The method of claim 8, wherein the underlying data container is a data file representing the designated data model in a JavaScript Object Notation (JSON) format.

10. The method of claim 9, wherein the graphical representation of the agreed data model is generated in connection with a graphical modeling tool.

11. The method of claim 10, wherein displaying the one or more hierarchically arranged core data services views to enable a user to identify the core data services view to be created further comprises displaying the one or more hierarchically arranged core data services views as a multiply hierarchical data model comprising more than one level of hierarchy.

12. The method of claim 11, wherein the core data services view comprises one or more private views.

13. The method of claim 10, wherein displaying the one or more hierarchically arranged core data services views is performed in connection with a hierarchical object rendering framework.

14. The method of claim 8, wherein generating the data services source code further comprises providing an integrated development environment in which a user may further edit initially generated code.

15. A system for automated data services source code generation based on an agreed data model, the system comprising:
at least one processor;
and at least one non-transitory memory storing computer executable instructions that when executed by the at least one processor cause the system to carry out actions comprising:
receiving a graphical representation of the agreed data model;
transforming the graphical representation of the agreed data model into a data file corresponding to the graphical representation of the agreed data model;
displaying one or more hierarchically arranged core data services views to enable a user to identify a core data services view to be created;
receiving a selection of a selected core data services view associated with the one or more hierarchically arranged core data services views; and
generating the data services source code based on imported contents associated with an underlying data file and the selected core data services view,
wherein the generated source code is compliant with virtual data model requirements.

16. The system of claim 15, wherein the graphical representation of the agreed data model is generated in connection with a graphical modeling tool.

17. The system of claim 15, wherein displaying the one or more hierarchically arranged core data services views to enable the user to identify the core data services view to be created further comprises displaying the one or more hierarchically arranged core data services views as a multiply hierarchical data model comprising more than one level of hierarchy.

18. The system of claim 17, wherein the core data services view comprises one or more private views.

19. The system of claim 18, wherein displaying the one or more hierarchically arranged core data services views is performed in connection with a hierarchical object rendering framework.

20. The system of claim 17, wherein generating the data services source code further comprises providing an integrated development environment in which the user may further edit initially generated code.
